(19) United States
(12) Patent Application Publication
(10) Pub. No.: US 2023/0361701 A1
(43) Pub. Date: Nov. 9, 2023

(54) FIELD WINDING CIRCUIT FOR AN ALTERNATOR, ALTERNATOR COMPRISING THE SAME, AND ASSOCIATED METHODS

(71) Applicant: VOLVO TRUCK CORPORATION, Göteborg (SE)

(72) Inventors: Niveditha KRISHNAKUMAR, Chennai (IN); Ranjith Kumar BASKARAN, Bangalore (IN)

(73) Assignee: VOLVO TRUCK CORPORATION, Göteborg (SE)

(21) Appl. No.: 18/312,139

(22) Filed: May 4, 2023

(30) Foreign Application Priority Data
May 6, 2022 (EP) 22172131.9

(51) Int. Cl. H02P 9/48

(52) U.S. Cl. CPC H02P 9/48; H02P 2101/25

(57) ABSTRACT

A field winding circuit for an alternator includes an electromagnetic coil including a first winding portion and a second winding portion electrically connected in series. The winding circuit comprises a first switch, a second switch and a third switch configured to selectively connect one or both of the first and second winding portions to output terminals of the winding circuit. The winding circuit comprises an electronic controller configured to: determine the output power required by an electrical load connected to the stator output terminals, compare the required output power to a threshold value, connect only one of the first and second winding portions to the output terminals if the required output power is below the threshold value and connect both the first and second winding portions to the output terminals if the required output power is below the threshold value.

### TECHNICAL FIELD

The present disclosure relates to alternators for use in motor vehicles.

The invention is, for example, applicable to the field of industrial vehicles, especially heavy-duty and medium-duty vehicles, such as trucks, buses, construction equipment and the like.

### BACKGROUND

Alternators are commonly used in motor vehicles to generate electric power when the vehicle is moving or when an internal engine of the vehicle is running. The electric power generated by the alternator can be used to charge an electric battery of the vehicle.

Alternators usually comprise a rotor, a stator, one or more magnets affixed to either the rotor or the stator, and a stator winding circuit capable of generating a voltage when a magnetic field created by the magnet(s) or electromagnets (field/rotor winding circuit) is moving relative to the stator/armature winding circuit.

In many automotive applications, the output voltage and the output electric power generated by the alternator are regulated using specific circuitry such as voltage regulators, power converters, or the like, so that the output power can match the electric power required by the electric loads connected to the alternator.

There are two ways to generate the required output from the alternator. First method is by increasing the number of turns in the field circuit winding and the second method is by increasing the current given to the field circuit winding. Generally, the second method is opted as changing the number of turns for the field circuit winding will not be possible once a design is frozen. But, this patent provides a solution to effectively use the first method.

### SUMMARY

An aspect of the invention relates to a winding circuit for an alternator, comprising an electromagnetic coil including a first field winding portion and a second field winding portion electrically connected in series,

wherein the field winding circuit comprises a first switch, a second switch and a third switch configured to selectively connect one or both of the first and second field winding portions to output terminals of the electronic voltage regulator,
wherein the field winding circuit comprises an electronic controller configured to:
determine the output electric power required by an electrical load connected to the output terminals of the stator winding circuit,
compare the required output electric power to a threshold value,

connect only one of the first and second winding portions to the output terminals if the required output electric power is below the threshold value and connect both the first and second winding portions to the output terminals if the required output electric power is higher than the threshold value.

In some embodiments, the first switch is connected between a first output terminal of the electronic voltage regulator and a first terminal of the first winding portion, wherein the second switch is connected between a second output terminal of the electronic voltage regulator and a second terminal of the first winding portion, the second terminal of the first winding portion being connected to a first terminal of the second winding portion and wherein the third switch is connected between a third output terminal of the electronic voltage regulator and a second terminal of the second winding portion.

In some embodiments, the first switch, the second switch and the third switch are electronic switches, for example semiconductor switches, such as transistors.

In some embodiments, the electronic controller is configured to determine required output power using a sensor connected to the electronic controller

In some embodiments, the electronic controller is configured to estimate the required output power by automatically querying the state of the electric load 18 using a communications link.

In some embodiments, the first winding portion and a second winding portion are connected together through an electrical midpoint of the electromagnetic coil.

Another aspect of the invention relates to an alternator comprises a rotor, a stator, and at least one winding circuit as described above.

Another aspect of the invention relates to a motor vehicle comprising an alternator as described above.

The field windings may be split into more windings portions with the same or the different number of turns or coil sizes.

In some embodiments, the motor vehicle is an industrial vehicle, for example a heavy-duty vehicle or a medium-duty vehicle, such as trucks, buses, or construction equipment, or Marine Engines, or Diesel Generator sets.

Another aspect of the invention relates to a method for controlling a field winding circuit for an alternator, comprising an electromagnetic coil including a first field winding portion and a second winding portion electrically connected in series, wherein the winding circuit comprises a first switch, a second switch and a third switch configured to selectively connect one or both of the first and second winding portions to output terminals of the Electronic Voltage regulator, wherein the method comprises, by an electronic controller of the winding circuit:
determining the output electric power required by an electrical load 18 connected to the output terminals of the Electronic Voltage regulator,
comparing the required output electric power to a threshold value,
connecting only one of the first and second winding portions to the output terminals if the required output electric power is below the threshold value and connect both the first and second winding portions to the output terminals if the required output electric power is higher than the threshold value.

### BRIEF DESCRIPTION OF THE DRAWINGS

The invention will be understood upon reading the following description, provided solely as an illustrative example, and made in reference to the appended drawings, in which:

FIG. 1 is a simplified diagram of an industrial vehicle comprising an alternator according to embodiments of the invention,

FIG. 2 is a simplified electrical diagram of an alternator according to embodiments of the invention,

FIG. 3 is a block diagram of an exemplary method of operation of the winding circuit of FIG. 2.

### DETAILED DESCRIPTION OF SOME EMBODIMENTS

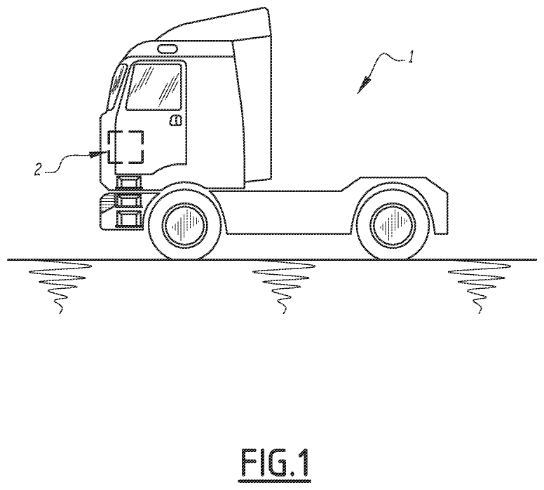

FIG. 1 illustrates a motor vehicle 1 comprising at least one alternator 2.

In preferred embodiments, the vehicle 1 is a heavy-duty or medium-duty vehicle.

In other embodiments, the vehicle 1 can be any industrial vehicle, preferably a wheeled industrial vehicle, such as a tractor, or a bus, or a dump-truck, or a military ground vehicle, or a heavy-duty construction vehicle such as a loader, a bulldozer, an excavator, a compactor, a scraper, or any equivalent vehicle.

In some embodiments, the alternator 2 can be used independently of any vehicle 1, for example in internal combustion engines such as marine engines or diesel generator sets. The description that will follow can be transposed to these embodiments, the reference to a vehicle 1 being optional.

The vehicle 1 comprises an engine, or motor, such as an internal combustion engine or an electric traction motor.

The alternator 2 is configured to generate electric power when the vehicle 1 is moving or when an internal engine of the vehicle 1 is running. For example, the alternator 2 is mechanically coupled to one or more wheels of the vehicle 1 or to an engine of the vehicle 1 (e.g. to an output shaft of the engine).

The alternator 2 may be used to supply electric power to one or more electric loads of the vehicle 1, for example to charge an electric battery of the vehicle.

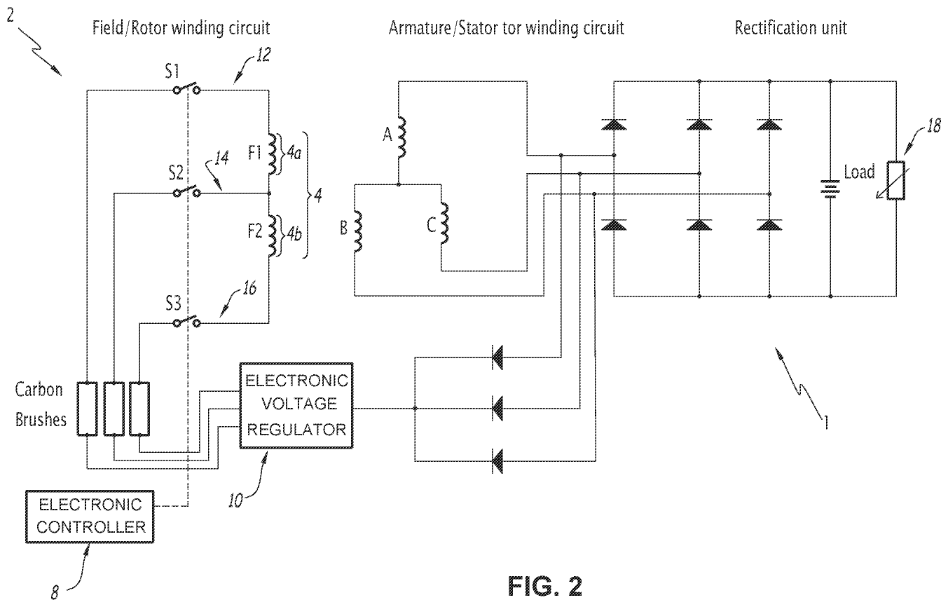

An exemplary electric load 18 is illustrated on the diagram of FIG. 2.

In many embodiments, the alternator 2 comprises a rotor and a stator. The alternator 2 may also comprise at least one magnet. The rotor of the alternator 2 may be a brushed or a brushless alternator.

In many examples, either the rotor is mechanically coupled to a wheel of the vehicle 1 or to the engine of the vehicle 1. The magnets, whenever they are present, are attached to either the rotor or the stator. The magnets may be permanent magnets and/or electromagnets.

The alternator 2 comprises a winding circuit.

The winding circuit in the stator can produce a constant output voltage with required current. The winding circuit in the rotor is excited by providing a DC current, which will create a magnetic field in the rotor. When the rotor rotates, this field of force cuts through the three phases of the stationary stator winding (noted as A, B and C in the example of FIG. 2) and during a complete 360° rotation induces sinusoidal waves in each phase (the exact number of sinusoidal waves depends on the number of pole pairs). The generated current is divided into primary current (Output current) and excitation current (input to the field coil via regulator circuit). After rectification, the primary current flows as operating current output terminal to the battery and to the loads

FIG. 2 schematically illustrates an example of a winding circuit for the alternator 2.

To simplify the disclosure of the invention, known elements of the alternator 2 such as the rotor and the stator are not illustrated on FIG. 2.

The winding circuit comprises an electromagnetic coil 4 (or winding) including a first field winding portion 4a (having an inductance F1) and a second field winding portion 4b (having an inductance F2) electrically connected in series. In other words, the electromagnetic coil 4 is subdivided into the two winding portions 4a and 4b.

In preferred embodiments, the first field winding portion 4a and the second field winding portion 4b can be same or different based on the design that is requested. For example, the first field winding portion 4a and the second field winding portion 4b have the same/different inductance and resistance value and/or the same/different length and/or the same/different coil diameter and/or the same/different number of individual coils.

In the illustrated example, the first field winding portion 4a and a second field winding portion 4b are connected together through an electrical node 6 of the electromagnetic coil.

The winding circuit comprises a first switch S1, a second switch S2 and a third switch S3 configured to selectively connect one or both of the first and second winding portions to output terminals of the winding circuit.

Each switch S1, S2 and S3 can be reversibly switched between an open state and a closed state.

In preferred embodiments, the first switch S1, the second switch S2 and the third switch S3 are electronic switches, for example semiconductor switches, such as transistors (e.g. MOSFETs, or Insulated Gate Bipolar Transistors or any suitable power switch).

The alternator 2 comprises of a field winding circuit, a stator winding circuit, an electronic voltage regulator and an electronic controller 8 capable of operating the switches S1, S2 and S3. For example, outputs of the electronic controller 8 are connected to the respective control electrodes (such as transistor gate electrodes) of the switches S1, S2 and S3.

In this disclosure, the expression “electronic controller” refers not only to electronic controller devices such as a processor, or a microprocessor, or a microcontroller, but also to other electronic devices and circuits such as programmable logic controllers (PLC), application-specific integrated circuits (ASIC), field-programmable gate array (FGPA) circuits, digital signal processing (DSP) circuits, graphical processing units (GPU), logic circuits, analog circuitry, equivalents thereof, and any other circuit or processor capable of executing the functions described herein.

The field winding circuit comprise output terminals configured to be electrically connected to at least one electronic voltage regulator 10. The electrical loads may, for example, be connected to the electronic voltage regulator 10. In some embodiments, the functions of the electronic controller 8 can also be integrated in the electronic Voltage regulator 10.

In the illustrated example, the electronic voltage regulator 10 is capable of regulating the output voltage generated by the stator winding circuit of the alternator 2 by controlling the input provided to the electromagnetic coil 4. For example, the voltage generator can distribute the output power to one or more electrical loads 18 through a power distribution bus (e.g. through connectors such as a busbar).

In other embodiments, the load 18 may be, for example, an electricity storage system such as a battery.

The exemplary system 3 depicted on FIG. 2 also comprises a stator winding circuit and a rectification unit (rectification circuit) comprising diode rectifiers. The three phases of the stator winding circuit may optionally be connected to the electronic voltage regulator 10, eventually with protection diodes as in the illustrated example

In the illustrated example, the first switch S1 is connected between a first output terminal of the electronic voltage regulator 10 and a first terminal 12 of the first winding portion 4a.

The second switch S2 is connected between a second output terminal of the electronic voltage regulator 10 and a second terminal 14 of the first winding portion 4a.

In this example, the second terminal 14 of the first field winding portion 4a is connected to a first terminal of the second winding portion (for example through the node 6).

The third switch S3 is connected between a third output terminal of the electronic voltage regulator and a second terminal 16 of the second winding portion 4b.

In some embodiments, as illustrated on the example of FIG. 2, optional carbon brushes may be connected between the switches S1, S2, S3 and the corresponding terminal of the electronic voltage regulator 10.

In this example, the switches S1, S2 and S3 can be controlled to place the winding circuit into one of three possible configurations.

In a first configuration, the first field winding portion 4a is connected to the output terminals of the electronic voltage regulator 10 and the second field winding portion 4b is disconnected from the output terminals of the electronic voltage regulator by closing the first switch S1 and the second switch S2 and keeping the third switch S3.

In a second configuration, the second field winding portion 4b is connected to the output terminals of the electronic voltage regulator 10 and the first field winding portion 4a is disconnected from the output terminals of the electronic voltage regulator by closing the second switch S2 and the third switch S3 and keeping the first switch S1 is open.

In a third configuration, both the first field winding portion 4a and the second field winding portion 4b are connected to the output terminals of the electronic voltage regulator by closing the second switch S1 and the third switch S3 and keeping the first switch S2 is open.

Thus, in both the first configuration and the second configuration, only part of the electromagnetic coil 4 is connected to the electronic voltage regulator 10. The output power generated by the stator winding circuit (and the alternator 2) in the above mentioned configuration (1&2) is lower than when both the first field winding portion 4a and the second field winding portion 4b are connected.

In accordance with embodiments of the invention, the electronic controller 8 is configured to:
determine the output electric power required by the electrical load 18 connected (directly or indirectly) to the output terminals of the stator winding circuit,
compare the required output electric power to a threshold value,
connect only one of the first or second field winding portions 4a/4b to the output terminals of the electronic voltage regulator 10 if the required output electric power is below the threshold value and connect both the first and second winding portions to the output terminals if the required output electric power is higher than the threshold value.

A technical advantage of this invention is the load dependency on the electromagnetic coil 4 can be reduced. If one of the coils is damaged, the other coil(s) can always support for power generation.

In some embodiments, the electronic controller 8 is configured to determine required output power using a sensor connected to the electronic controller

In some other embodiments, the electronic controller 8 is configured to estimate the required output power by automatically querying the state of the electric load 18 using a communications link (not illustrated).

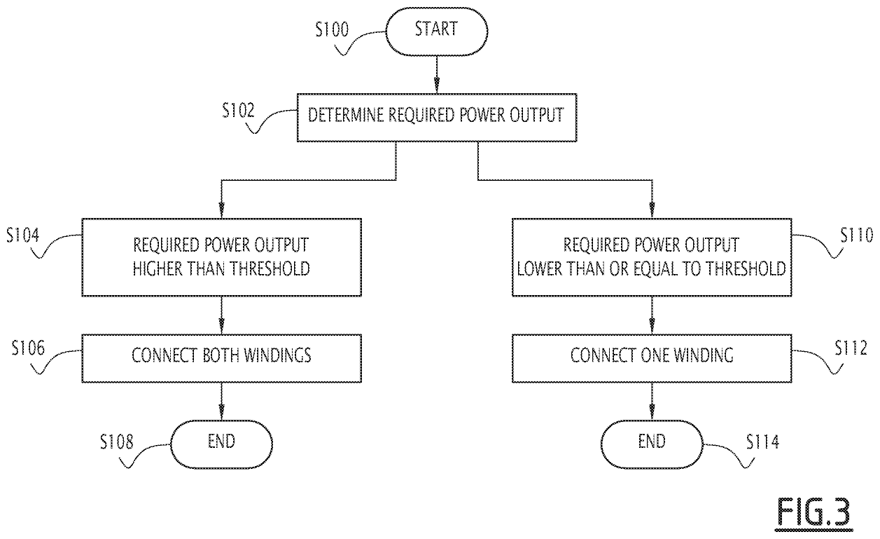

An example of operation is now described in reference to FIG. 3.

The method begins at block S100, for example in response to an action initiated by a user (such as starting the vehicle 1) or in response to a query by another electronic controller coupled to the electric load 18.

At block S102, the electronic controller 8 determines the output electric power required by the electrical load 18.

During a subsequent step, the determined output power is compared to a threshold value, e.g. a threshold value stored in a memory of the electronic controller 8.

If the required output power is found to be above the threshold value (e.g. higher than the threshold value—block S104), then in response, the electronic controller 8 automatically connects both the first field winding portion 4a and the second field winding portion 4b of the electromagnetic coil 4 to the output terminals of the electronic voltage controller 10 (block S106) in order to maximize the output power of the winding circuit (and of the alternator 2). For example, the electronic controller 8 closes the switches S1 and S3 by sending suitable control signal to their respective control electrodes. The first prong of the method ends at block S108.

If the required output power is found to be below the threshold value (e.g. equal to or lower than the threshold value—block S110), then in response, the electronic controller 8 automatically connects only one of the first field winding portion 4a or the second field winding portion 4b of the electromagnetic coil 4 to the output terminals of the electronic voltage controller 10 (block S112) in order to reduce the output power of the winding circuit (and of the alternator 2). For example, the electronic controller 8 closes the second switch S2 and only one of either the first switch S1 or the third switch S3, by sending suitable control signal to their respective control electrodes. The second prong of the method ends at block S114.

In alternative embodiments, the method steps described above could be executed in a different order. One or more method steps could be omitted or replaced by equivalent steps. Some method steps could be combined or dissociated into different method steps.

The disclosed exemplary embodiment is not intended to be limiting and does not prevent other methods steps to be executed without departing from the scope of the claimed subject matter.

Other embodiments are possible.

For example, the field windings may be split into more windings portions with the same or the different number of turns or coil sizes.

The stator winding circuit can be connected in a star configuration (as in the example of FIG. 2) or in a delta configuration.

The method described above can be used either in brushed alternators or in brushless alternators. When used in a brushed alternator, the number of brushes can be chosen (e.g., increased) according to the number of windings portions.

The method is not restricted to an alternator in a vehicle but can also be used for marine generators or generator sets (e.g., gensets) or integrated starter generators.

The embodiments and alternatives described above may be combined with each other in order to create new embodiments of the invention.

1. A field winding circuit for an alternator, comprising an electromagnetic coil including a first field winding portion and a second field winding portion electrically connected in series,
wherein the field winding circuit comprises a first switch, a second switch and a third switch configured to selectively connect one or both of the first and second winding portions to output terminals of the field winding circuit,
wherein the field winding circuit comprises an electronic controller configured to:
determine the output electric power required by an electrical load connected to an electronic voltage regulator connected to the output terminals of the stator winding circuit,
compare the required output electric power to a threshold value,
connect only one of the first and second winding portions to the output terminals if the required output electric power is below the threshold value and connect both the first and second winding portions to the output terminals if the required output electric power is higher than the threshold value.

2. The field winding circuit of claim 1, wherein the first switch is connected between a first output terminal of the electronic voltage regulator and a first terminal of the first winding portion, wherein the second switch is connected between a second output terminal of the electronic voltage regulator and a second terminal of the first winding portion, the second terminal of the first winding portion being connected to a first terminal of the second winding portion and wherein the third switch is connected between a third output terminal of the electronic voltage regulator and a second terminal of the second winding portion.

3. The winding circuit of claim 1, wherein the first switch, the second switch and the third switch are electronic switches, for example semiconductor switches, such as transistors.

4. The winding circuit according to claim 1, wherein the electronic controller is configured to determine required output power using a sensor connected to the electronic controller.

5. The winding circuit according to claim 1, wherein the electronic controller is configured to estimate the required output power by automatically querying the state of the electric load using a communications link.

6. The winding circuit according to claim 1, wherein the first winding portion and a second winding portion are connected together through an electrical node of the electromagnetic coil.

7. The winding circuit according to claim 1, wherein the field windings are split into more windings portions with the same or the different number of turns or coil sizes.

8. An alternator comprising a rotor, a stator, and at least one winding circuit according to claim 1.

9. A motor vehicle comprising an alternator according to claim 8.

10. The motor vehicle of claim 9, wherein the motor vehicle is an industrial vehicle, for example a heavy-duty vehicle or a medium-duty vehicle, such as trucks, buses, or construction equipment.

11. A method for controlling a field winding circuit for an alternator, comprising an electromagnetic coil including a first field winding portion and a second field winding portion electrically connected in series, wherein the field winding circuit comprises a first switch, a second switch and a third switch configured to selectively connect one or both of the first and second winding portions to output terminals of the winding circuit, wherein the method comprises, by an electronic controller of the winding circuit:
determining the output electric power required by an electrical load connected to the output terminals of the field winding circuit,
comparing the required output electric power to a threshold value,
connecting only one of the first or second winding portions to the output terminals if the required output electric power is below the threshold value and connect both the first and second winding portions to the output terminals if the required output electric power is higher than the threshold value.
